(19) United States
(12) Patent Application Publication
(10) Pub. No.: US 2005/0124819 A1
(43) Pub. Date: Jun. 9, 2005

(54) Metal-organic polyhedra

(75) Inventors: Omar M. Yaghi, Ann Arbor, MI (US); Andrea C. Sudik, Canton, MI (US)

Correspondence Address: BROOKS KUSHMAN P.C., 1000 TOWN CENTER, TWENTY-SECOND FLOOR, SOUTHFIELD, MI, 48075, US

(73) Assignee: The Regents of the University of Michigan, Ann Arbor, MI (US)

(21) Appl. No.: 11/004,696

(22) Filed: Dec. 3, 2004

Related U.S. Application Data
(60) Provisional application No. 60/527,456, filed on Dec. 5, 2003.

(51) Int. Cl. C07F 15/02

(52) U.S. Cl. 556/148

(57) ABSTRACT

The present invention provides porous metal-organic polyhedra. The porous metal-organic polyhedra of the present invention comprises a plurality of metal clusters each of which have two or more metal ions, and a sufficient number of capping ligands to inhibit polymerization of the metal organic polyhedra. The porous metal-organic polyhedra further includes a plurality of multidentate linking ligands that connect adjacent metal clusters into a geometrical shape describable as a polyhedral with metal clusters positioned at one or more vertices of the polyhedron. The present invention also provides a method of making the porous metal-organic polyhedra in which a solution comprising a solvent, one or more ions, and a counterions that complexes to the porous metal-organic polyhedra as a capping ligand to inhibit polymerization of the metal organic polyhedra, with a multidentate linking ligand.

### CROSS-REFERENCE TO RELATED APPLICATIONS

This application claims the benefit of U.S. Provisional Application Ser. No. 60/527,456 filed Dec. 5, 2003.

### BACKGROUND OF THE INVENTION

1. Field of the Invention

In at least one embodiment, the present invention relates to porous metal-organic polyhedra formed by linking ligands attached to a metal cluster.

2. Background Art

Extensive research has been devoted to the synthesis and characterization of metal-organic polygons and polyhedra (MOPs) such as squares, cubes, tetrahedra, and hexahedra. Their structures have been constructed from nodes of either single metal ions or metal carboxylate clusters that are joined by organic links. MOPs have voids within their structures where guest solvent molecules or counter-ions reside. Although reports of studies exploring the mobility of such guests have appeared, the question of whether MOPs can support permanent porosity in the absence of guests remains unanswered. We believe that the utility of MOPs in catalysis, gas sorption, separation and sensing applications hinges upon their ability to remain open in the absence of guests. In other words, their molecular structure should be architecturally robust to allow for removal of guests without destruction of the pores, precluding their use as porous materials. Furthermore, MOPs with permanent porosity should allow for unhindered inclusion and removal of gas molecules and full access to adsorption sites within the pores.

In the area of microporous materials a wealth of conceptual approaches have been developed for preparing extended structures with high porosity and reversible Type I behavior. For zeolites, apparent surface areas up to 500 m²/g for faujacite and pore volumes up to 0.47 cm³/cm³ for zeolite A have been reported. Metal-organic frameworks have been designed with apparent surface areas and pore volumes up to 4500 m²/g and 0.69 cm³/cm³ for MOF-177. While gas uptake in metal-organic polygonal and polyhedral assemblies have been investigated, reversible Type I behavior has been not been demonstrated. Such lack of permanent porosity is most likely attributed to the flexible nature of the single metal ion vertice.

Accordingly, there exists a need for novel MOP structures that exhibit Type I isothermal behavior.

### SUMMARY OF THE INVENTION

In at least one embodiment, the present invention provides a solution to one or more problems of the prior art. The present invention represents an extension of the prior art methodology for construction of porous two- and three-dimensional metal-organic frameworks (“MOFs”). Specifically, the present invention represents novel molecular chemistry where nodes (i.e., vertices) are capped metal carboxylate clusters in which the metal atoms are firmly locked into position by the multidentate carboxylate links to allow for the formation of rigid polyhedral structures that support permanent porosity, and in particular, Type I isothermal behavior. The porous metal-organic polyhedra of the present invention comprise a plurality of metal clusters. Each metal cluster comprises two or more metal ions, and a sufficient number of capping ligands to inhibit polymerization of the metal organic polyhedra. The porous metal-organic polyhedra further includes a plurality of multidentate linking ligands that connect adjacent metal clusters into a geometrical shape describable as a polyhedron with metal clusters positioned at one or more vertices of the polyhedron. In this study, the SBU approach has been successfully applied to generate a series of discrete, microporous polyhedra with unprecedented reversible Type I behavior as well as apparent surface areas comparable to MOFs and some of the most porous zeolites.

In another embodiment of the present invention, a method of forming the porous metal-organic polyhedra set forth above is provided. The method of this embodiment comprises combining a solution comprising a solvent, one or more metal ions, and one or more counterions or neutral ligands that complex to the porous metal-organic polyhedra as capping ligands to inhibit polymerization of the metal organic polyhedra, with a multidentate linking ligand.

In another embodiment of the invention, a method of systematically designing MOPs with increasing pore size is provided. The method of this embodiment is advantageously used to increase pore volumes until a desired size or absorption amount is achieved. Generally, large pores with high adsorption capacities are desired. The method of the invention comprises selecting a first multidentate ligand Y as set forth above in formula I (XₙY). Forming a first MOP with the first multidentate ligand. Typically, the first MOP is formed by the method set forth above. Next, a measurement of the pore size or adsorption of a chemical species for the first MOP is performed. A second MOP is then formed from a second multidentate ligand. The second multidentate ligand is characterized by comprising a larger number of atoms than the first multidentate ligand. Next, a second measurement of the pore size or adsorption of a chemical species for the second MOP is performed. The process is iteratively repeated until a ligand with a sufficient number of atoms is identified which yields the desired gas uptake.

### BRIEF DESCRIPTION OF THE DRAWINGS

FIG. 1 provides the following structure: Schematic representation of the secondary building unit (“SBU”) approach used to prepare the metal-organic polyhedra (“MOP”). This strategy employs (a) Fe₃O(CO₂)₆ clusters, (b) trigonal prismatic SBUs, that are (c) capped with sulfate yielding trigonal SBUs. These SBUs, together with either (d) linear (BDC, BPDC, HPDC, and TPDC) or (e) trigonal (BTB) links produce truncated tetrahedral or heterocuboidal polyhedra, respectively. The sphere within each polyhedron represents the size of the largest sphere that would fit within the cavity without touching the interior van der Waals surface of the polyhedron;

FIG. 2 provides the single crystal X-ray structures of IRMOP-n (n=50 to 53) and MOP-n (n=54). The spheres are as in FIG. 1. All hydrogen atoms and guests have been omitted and only one orientation of disordered atoms is shown for clarity; and

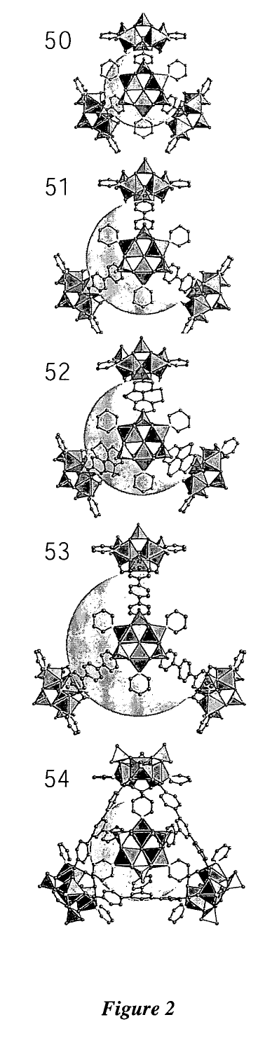

FIG. 3 provides plots of gas and organic vapor sorption isotherms (filled points, sorption; open points, desorption) for IRMOP-51 (squares), IRMOP-53 (circles), and MOP-54 (triangles). P/Po is the ratio of gas pressure (P) to saturation pressure (Po).

### DETAILED DESCRIPTION OF THE PREFERRED EMBODIMENT(S)

Reference will now be made in detail to presently preferred compositions or embodiments and methods of the invention, which constitute the best modes of practicing the invention presently known to the inventors.

As used herein “linking ligand” means a chemical species (including neutral molecules and ions) that coordinate to two or more metals resulting in an increase in their separation, and the definition of void regions or channels in the framework that is produced. Examples include 4,4′-bipyridine (a neutral, multiple N-donor molecule) and benzene-1,4-dicarboxylate (a polycarboxylate anion).

As used herein “capping ligand” means a chemical species that is coordinated to a metal but does not act as a linker. The non-linking ligand may still bridge metals, but this is typically through a single coordinating functionality and therefore does not lead to a large separation. In the present invention capping ligands inhibit polymerization of the metal organic polyhedra.

As used herein “guest” means any chemical species that resides within the void regions of an open framework solid that is not considered integral to the framework. Examples include: molecules of the solvent that fill the void regions during the synthetic process, other molecules that are exchanged for the solvent such as during immersion (via diffusion) or after evacuation of the solvent molecules, such as gases in a sorption experiment.

As used herein “charge-balancing species” means a charged guest species that balances the charge of the framework. Quite often this species is strongly bound to the framework, i.e. via hydrogen bonds. It may decompose upon evacuation to leave a smaller charged species (see below), or be exchanged for an equivalently charged species, but typically it cannot be removed from the pore of a metal-organic framework without collapse.

As used herein “space-filling agent” means a guest species that fills the void regions of an open framework during synthesis. Materials that exhibit permanent porosity remain intact after removal of the space-filling agent via heating and/or evacuation. Examples include: solvent molecules or molecular charge-balancing species. The latter may decompose upon heating, such that their gaseous products are easily evacuated and a smaller charge-balancing species remain in the pore (i.e. protons). Sometimes space filling agents are referred to as templating agents.

In one embodiment, the present invention provides porous metal-organic polyhedra. The porous metal-organic polyhedra of the present invention comprises a plurality of metal clusters. Each metal cluster comprises two or more metal ions, and a sufficient number of capping ligands to inhibit polymerization of the metal organic polyhedra. The porous metal-organic polyhedra further includes a plurality of multidentate linking ligands that connect adjacent metal clusters into a geometrical shape describable as a polyhedron with metal clusters positioned at one or more vertices of the polyhedron. Moreover, the metal-organic polyhedra of the present invention remain porous in the absence of a templating agent. Typically, the plurality of multidentate linking ligands have a sufficient number of accessible sites and/or atomic or molecular adsorption. “Edges” as used herein means a region within the pore volume in proximity to a chemical bond (single-, double-, triple-, aromatic-, or coordination-) where sorption of a guest species may occur. For example, such edges include regions near exposed atom-to-atom bonds in an aromatic or non-aromatic group. Exposed meaning that it is not such a bond that occurs at the position where rings are fused together. It should also be appreciated that sorptive sites include the multidentate linking ligand and the metal clusters. Although several methods exist for determining the surface area, particularly useful methods are the Langmuir and BET surface area methods. In variations of the invention, the plurality of multidentate linking ligands has a sufficient number of accessible sites (i.e. edges) for atomic or molecular adsorption that the surface area per gram of material is greater than 200 m²/g. In other variations, the plurality of multidentate linking ligands has a sufficient number of accessible sites (i.e., edges) for atomic or molecular adsorption that the surface area per gram of material is greater than about 300 m²/g. In still other variations, the plurality of multidentate linking ligands has a sufficient number of accessible sites (i.e., edges) for atomic or molecular adsorption that the surface area per gram of material is greater than about 400 m²/g. The upper limit to the surface area will typically be about 18,000 m²/g. More typically, the upper limit to the surface area will be about 10000 m²/g. In other variations, the upper limit to the surface area will be about 500 m²/g.

As set forth above, each metal cluster of the porous metal-organic polyhedra of the invention comprises two or more metal ions. In other variations, each metal cluster comprises three or more metal ions. The capping ligands which are included in the metal cluster typically are Lewis bases. Moreover, these capping ligands may be selected from the group consisting of anionic ions, neutral ligands, and combinations thereof. Examples of capping ligands include sulfate, nitrate, halogen, phosphate, amine, and mixtures thereof.

The porous metal-organic polyhedra of the present invention are characterized by the pore volume per gram of material (polyhedra). Typically, the metal-organic polyhedra have a pore volume per gram of metal-organic polyhedra greater than about 0.1 cm³/cm³.

The porous metal-organic polyhedra include metal clusters comprising two or more metal ions. Examples of suitable metal ions include Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, C²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof.

In a variation of this embodiment, the porous metal-organic polyhedra include metal clusters that comprise three or more metal ions. Again, examples of suitable metal ions include Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, C²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof. In a particularly useful variation, the metal cluster is Fe₃O(CO₂)₃(SO₄)₃.

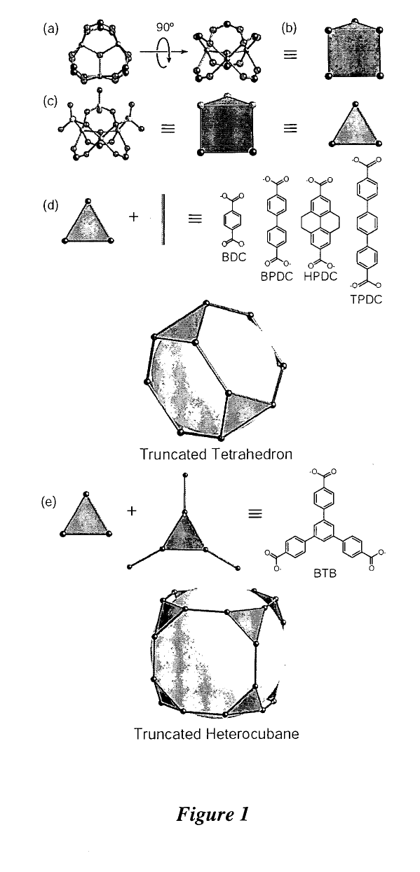

In a variation of the invention, the synthesis of robust and highly porous molecular tetrahedral is provided. In a particular example of this variation, employing metal carboxylate clusters instead of single metal ions as nodes yields stable architectures. Here, this strategy is extended to MOPs in which the common oxygen-centered trinuclear clusters, Fe₃O(CO₂)₆, are employed as nodes (FIG. 1a). The carboxylate carbon atoms are the points-of-extension that represent the vertices of a trigonal prismatic secondary building unit (SBU) (FIG. 1b). This SBU can be linked at all six points-of-extension by ditopic links to give 3-D extended MOFs. In this study, three cofacial sites on the SBU have been capped by bridging sulfate groups to yield a triangular SBU (FIG. 1c) which predisposes the carboxylates at 60° to each other. Linking these shapes together by either ditopic links such as 1,4-benzenedicarboxylate (BDC), 4,4′-biphenyldicarboxylate (BPDC), tetrahydropyrene-2,7-dicarboxylate (HPDC), and 4,4″-terphenyldicarboxylate (TPDC) or a tritopic link such as 1,3,5-tris(4-carboxyphenyl)benzene (BTB) gives porous truncated tetrahedra or a truncated heterocubane, respectively (FIG. 1d and e).

For this series of compounds the size of the pore and its opening can be systematically varied without altering the polyhedral shape. Specifically, the synthesis and single crystal X-ray structures of each member of this series are described and, for three members, the gas sorption isotherms are reported. The latter data provides conclusive evidence that these discrete structures are architecturally robust and are indeed capable of gas adsorption typical of materials with permanent porosity.

The porous metal-organic polyhedra of the present invention also includes a multidentate linking ligand. This linking ligand may be described by formula I:
XₙY I
wherein X is CO₂⁻, CS₂⁻, NO₂, SO₃⁻, and combinations thereof; n is an integer that is equal or greater than 2, and Y is a hydrocarbon group or a hydrocarbon group having one or more atoms replaced by a heteroatom. In a variation of the invention, X is CO₂⁻ and Y comprises a moiety selected from the group consisting of a monocyclic aromatic ring, a polycyclic aromatic ring, alkyl groups having from 1 to 10 carbons, and combinations thereof. In a further refinement of this variation, Y includes 12 or more atoms that are incorporated into aromatic rings. In another refinement of this variation, Y includes 16 or more atoms that are incorporated into aromatic rings. In yet another refinement of this embodiment, Y includes more than 16 atoms that are incorporated into aromatic rings. In another variation of this embodiment, Y is alkyl, alkyl amine, aryl amine, aralkyl amine, alkyl aryl amine, or phenyl. In yet another variation of this embodiment, Y is a C₁₋₁₀ alkyl, a C₁₋₁₀ alkyl amine, a C₇₋₁₅ aryl amine, a C₇₋₁₅ aralkyl amine, a C₇₋₁₅ alkyl aryl amine, or a C₁₀₋₂₄ aryl.

In a variation of this embodiment, the multidentate ligand includes at least two dentates (i.e., X in formula I) oriented linearly with respect to each other (i.e., an angle of about 180° between the two dentates when the ligand is in an unstrained state). Typcially, these ligands are ditopic organic ligands. In a specific example of this variation, the carboxyl groups in the capped triangular Fe₃O(CO₂)₃(SO₄)₃ unit provide the necessary 60° angles which are ideally suited for building tetrahedral shapes with such linear ligands. An example of a multidentate ligand in this variation is provided by formula II: 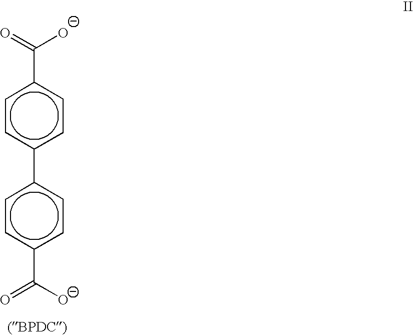
Moreover, an example of a porous metal-organic polyhedron incorporating a ligand having formula II has the formula [NH₂(CH₃)₂]₈[Fe₁₂O₄(BPDC)₆(SO₄)₁₂(py)₁₂]. (py is pryridine) Another particularly preferred multidentate linking ligand having two ligands linearly oriented is provided by formula III: 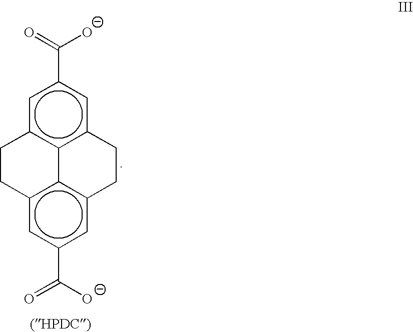
Similarly, an example of a porous metal-organic polyhedra incorporating a ligand having formula III is provided by the formula [NH₂(CH₃)₂]₈[Fe₁₂O₄(HPDC)₆(SO₄)₁₂(py)₁₂]. Another particularly preferred multidentate linking ligand has the formula IV: 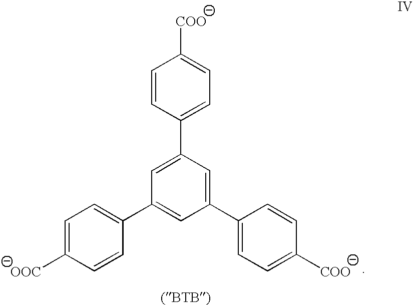
An example of a porous metal-organic polyhedra incorporating ligand IV has the formula [NH₂(CH₃)₂]₈[Fe₁₂O₄(BTB₆)₄(SO₄)₁₂(py)₁₂]. Additional useful multidentate ligands include ligands with formulae V and VI (corresponding to [NH₂(CH₃)₂]₈[Fe₁₂O₄(TPDC₆)₆(SO₄)₁₂(py)₁₂] (IRMOP-53) and [NH₂(CH₃)₂]₈[Fe₁₂O₄(BDC₆)₆(SO₄)₁₂(py)₁₂] (IRMOP-50))

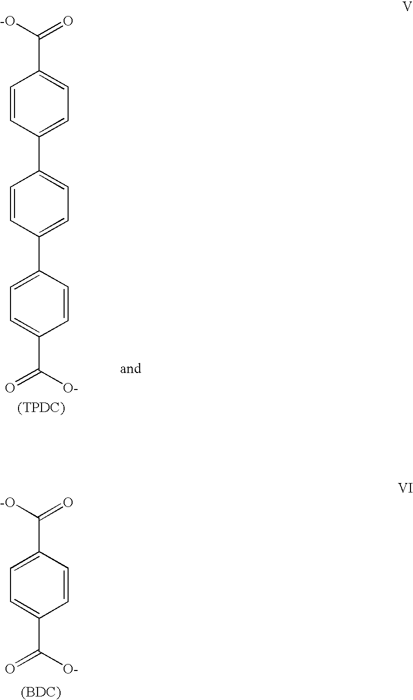

The porous metal-organic polyhedra of the present invention optionally further comprise space-filling agents, adsorbed chemical species, guest species, and combinations thereof. Suitable space-filling agents include, for example, a component selected from the group consisting of:

a. alkyl amines and their corresponding alkyl ammonium salts, containing linear, branched, or cyclic aliphatic groups, having from 1 to 20 carbon atoms;

b. aryl amines and their corresponding aryl ammonium salts having from 1 to 5 phenyl rings;

c. alkyl phosphonium salts, containing linear, branched, or cyclic aliphatic groups, having from 1 to 20 carbon atoms;

d. aryl phosphonium salts, having from 1 to 5 phenyl rings,

e. alkyl organic acids and their corresponding salts, containing linear, branched, or cyclic aliphatic groups, having from 1 to 20 carbon atoms;

f. aryl organic acids and their corresponding salts, having from 1 to 5 phenyl rings;

g. aliphatic alcohols, containing linear, branched, or cyclic aliphatic groups, having from 1 to 20 carbon atoms;

h. aryl alcohols having from 1 to 5 phenyl rings;

i. inorganic anions from the group consisting of sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, O²⁻, diphosphate, sulfide, hydrogen sulphate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, iodite, hypoiodite, and the corresponding acids and salts of said inorganic anions;

j. ammonia, carbon dioxide, methane, oxygen, argon, nitrogen, ethylene, hexane, benzene, toluene, xylene, chlorobenzene, nitrobenzene, naphthalene, thiophene, pyridine, acetone, 1,2-dichloroethane, methylenechloride, tetrahydrofuran, ethanolamine, triethylamine, trifluoromethylsulfonic acid, N,N-dimethyl formamide, N,N-diethyl formamide, dimethylsulfoxide, chloroform, bromoform, dibromomethane, iodoform, diiodomethane, halogenated organic solvents, N,N-dimethylacetamide, N,N-diethylacetamide, 1-methyl-2-pyrrolidinone, amide solvents, methylpyridine, dimethylpyridine, diethylethe, and mixtures thereof. Examples of adsorbed chemical species include ammonia, carbon dioxide, carbon monoxide, hydrogen, amines, methane, oxygen, argon, nitrogen, argon, organic dyes, polycyclic organic molecules, and combinations thereof. Finally, examples of guest species are organic molecules with a molecular weight less than 100 g/mol, organic molecules with a molecular weight less than 300 g/mol, organic molecules with a molecular weight less than 600 g/mol, organic molecules with a molecular weight greater than 600 g/mol, organic molecules containing at least one aromatic ring, polycyclic aromatic hydrocarbons, and metal complexes having formula MₘXₙ where M is metal ion, X is selected from the group consisting of a Group 14 through Group 17 anion, m is an integer from 1 to 10, and n is a number selected to charge balance the metal cluster so that the metal cluster has a predetermined electric charge; and combinations thereof. In some variations, adsorbed chemical species, guest species, and space-filling agents are introduced in the metal-organic polyhedra by contacting the metal-organic polyhedra with a pre-selected chemical species, guest species, or space-filling agent.

In another embodiment of the present invention, a method of forming the porous metal-organic polyhedra set forth above is provided. The method of this embodiment comprises combining a solution comprising a solvent, one or more metal ions, and one or more counterions that complex to the porous metal-organic polyhedra as capping ligands to inhibit polymerization of the metal organic polyhedra, with a multidentate linking ligand. The selection of the multidentate linking ligands, the capping ligands, and the metal ions is the same as set forth above. As set forth above, examples of metal ions are selected from the group consisting of Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, C²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, Bi⁺, and combinations thereof. The counterions (i.e., the counter ions) that are present in the solution are typically Lewis bases also as set forth above.

In a variation of this embodiment, the multidentate ligand has 12 or more atoms incorporated into aromatic rings. In other variation, the multidentate ligand has 16 or more atoms incorporated in aromatic rings. In yet another variation, the multidentate ligand has more than 16 atoms incorporated into aromatic rings.

Suitable counterions include, for example, sulfate, nitrate, halogen, phosphate, ammonium, and mixtures thereof. The selection of the multidentate linking agent is the same as those set forth above.

The solution used in the method of the present invention may also include space-filling agents. Examples of suitable space-filling agents are set forth above.

In another embodiment of the invention, a method of systematically designing a MOP with increasing pore size is provided. The method of this embodiment is advantageously used to increase pore volumes until a desired size or absorption amount is achieved. Generally, large pores with high adsorption capacities are desired. The method of the invention comprises selecting a first multidentate ligand as set forth above in formula I (XₙY). Forming a first MOP with the first multidentate ligand. Typically, the first MOP is formed by the method set forth above. Next, a measurement of the pore size or adsorption of a chemical species for the first MOP is performed. A second MOP is then formed from a second multidentate ligand. The second multidentate ligand is characterized by comprising a larger number of atoms than the first multidentate ligand (i.e., for example Y has a larger number of atoms). Next, a second measurement of the pore size or adsorption of a chemical species for the second MOP is performed. The process is iteratively repeated until a ligand with a sufficient number of atoms is identified which results in an optimal gas uptake. Specifically, multidentate linking ligands with an increasing number of atoms are successively used to form metal-organic polyhedra until a desired pore size or amount of adsorption of a chemical speices is achieved. Suitable multidentate ligands are the same as the multidentate ligands set forth above. A series of ligand with increasing numbers of atom in Y are in increasing order 1,4-benzenedicarboxylate (BDC), 4,4′-biphenyldicarboxylate (BPDC), tetrahydropyrene-2,7-dicarboxylate (HPDC), and 4,4″-terphenyldicarboxylate (TPDC). These ligands may be used to form the following MOP: [NH₂(CH₃)₂]₈[Fe₁₂O₄(BDC)₆(SO₄)₁₂(py)₁₂].G (“IRMOP-50”); [NH₂(CH₃)₂]₈[Fe₁₂O₄(SO4)₁₂ (BPDC)₆(py)₁₂].G (“IRMOP-51”); [NH₂(CH₃)₂]₈[Fe₁₂O₄(SO₄)₁₂(HPDC)₆(py)₁₂].G(“IRMOP-52”); [NH²(CH₃)₂]₈[Fe₁₂O₄(SO₄)₁₂(TPDC)₆(py)₁₂].G (“IRMOP-53”) and NH₂(CH₃)₂]₈[Fe₁₂O₄(SO₄)₁₂(BTB)₄(py)₁₂].G (“MOP-54”).

IRMOP 50-53 and MOP-54 were systematically evaluated to demonstrate the utility of this embodiment. The vertices of each member of this series are composed of Fe₃O(CO₂)₃(SO₄)₃(py)₃ units with the sulfates acting as capping groups that prevent the formation of extended structures. Thus the Fe₃O(CO₂)₃ is a triangular SBU that is then connected to three organic ditopic (IRMOP-50 to 53) or tritopic (MOP-54) links. In all cases the coordination sphere of each Fe atom is completed by a terminal pyridine ligand to give an overall 6-coordinate octahedral center. For each member of the series, eight dimethylammonium cations are found in the crystal structure to balance the overall 8− charge on each polyhedron. The identity of the cations is based on the well-established decarbonylation of DMF which is known to yield dimethylamine upon heating DMF in the presence of base. Comparison of the pKb values for crystallographically identified guest species (“G”), namely 8.81 for pyridine and 3.27 for dimethylamine, are consistent with the dimethylammonium counter-ion assignment. In general, it is difficult to completely formulate the composition of all the guests in the polyhedral series due to the volatility of the guest molecules, an aspect that is commonly found in MOFs. In addition, diffuse scattering and disorder prevent definitive assignment of guest molecules based on the single crystal X-ray data (see Experimental Section below for details). Elemental microanalysis has limited utility in this context since the guests contain the same elements that are present in the truncated polyhedra. Nevertheless, given that the guests ultimately will be evacuated or exchanged from the pores, and that the structure of the polyhedra has been determined definitively from the single crystal X-ray diffraction data, any ambiguity in the formulation of guest molecules does not preclude the use of IRMOPs as porous materials.

Magnetic measurements for IRMOPs 51, 53 and MOP-54. Magnetic susceptibility measurements of IRMOP-51, IRMOP-53, and −MOP-54 were performed in the temperature range of 5-300 K at a constant magnetic field of 5 kG. At 300 K the μ_{eff} values per iron center for IRMOP-51 (3.80 μ_{B}), IRMOP-53 (3.33 μ_{B}), and MOP-54 (3.29 μ_{B}) are considerably smaller than the calculated spin only value (5.92 μ_{B}) for three uncoupled S=5/2 spins, but fall within the range except for molecular [Fe^{III}₃O(RCO₂)₆L₃]⁺ systems (3.0 to 3.9 μB). All compounds exhibit a gradual decrease in magnetic moment to 1.85 μ_{B} (IRMOP-51), 1.44 μ_{B} (IRMOP-53), and 1.46 μ_{B} (MOP-54) at 5 K indicating anti-ferromagnetic interactions between iron centers. The low temperature μ_{eff} values do not extrapolate toward zero and are consistent with those previously reported molecular species. Based on this correlation between experimental and literature data and as similarly observed in analogous discrete polyhedral or infinite assemblies, long range coupling between clusters is presumed to be negligible.

Structure, Packing and Metrics. The packing of the polyhedra in the crystal reveals two kinds of pores within each -structure as illustrated for the cubic phase of IRMOP-51. The first, Pores A, are those within the polyhedra, and the second, Pores B, are between the polyhedra. The relative space provided by Pore A and Pore B in the series is dependent on their packing motifs. In the case of −MOP-54, the centers of the heterocubanes fall at the nodes of a diamond net, yielding the most densely packed arrangement. The two cubic phases of IRMOP-50 and IRMOP-51 are exceptional and much less dense. Here tetrahedra are widely spaced, and the centers of the tetrahedra are at the nodes of a face-centered cubic lattice. The vertices of the tetrahedra (taken as the three-coordinated O) form a cristobalite net (“crs”) For all polyhedra, the two types of pores are interconnected by virtue of each truncated polyhedron having four open triangular faces (IRMOP-50 to IRMOP-53) or six open edges (MOP-54). For the entire MOP series, all crystallographically identified counter-ions were found to reside in Pore B, typically in close proximity to the sulfate moieties of the polyhedra. Extensive hydrogen bonding between these dimethylammonium cations and the sulfate groups [(CH₃)₂H₂N^{+. . .} OSO₃²⁻ and ⁺NH₂(H₃C) . . . OSO₃²⁻ average non-bonding distances are 3.05 Å and 3.20 Å respectively] hold adjacent polyhedra together to yield a rigid labyrinth of pores within each structure. Metric parameters for this series are summarized in Table 1.

TABLE 1
Metric Parameters for Isoreticular Metal-Organic Polyhedra.

| | (IR)MOP-n | | | | | |
|---|---|---|---|---|---|---|
| | | 51 | 51 | | | |
| | 50 | (cubic) | (triclinic) | 52 | 53 | 54 |
| Van der Waals | 20.0 | 24.2 | 24.2 | 24.1 | 28.5 | 24.3 |
| length of | | | | | | |
| edge (Å) | | | | | | |
| free diameter | 3.8 | 6.4 | 6.4 | 4.0 | 9.4 | 3.6 |
| Pore A (Å)^{a} | | | | | | |
| fixed diameter Pore A | 7.0 | 10.2 | 10.2 | 10.2 | 13.4 | 9.0 |
| (Å)^{a} | | | | | | |
| % free volume | 25.8 | 16.0 | 21.3 | 21.2 | 25.3 | 27.2 |
| Pore A^{b} | | | | | | |
| % free volume | 45.4 | 63.0 | 44.2 | 42.3 | 50.5 | 28.8 |
| Pore B^{b} | | | | | | |
| % free volume | 71.2 | 79.0 | 65.5 | 63.5 | 75.8 | 56.0 |
| total (Pore | | | | | | |
| A + Pore B) | | | | | | |

^{a}Measurements calculated by diameter of sphere that can pass through (free) or occupy (fixed) Pore A without contacting the van der Waals surface of the polyhedron (including axial py molecules).
^{b}‘% free volume’ calculations performed using Cerius2 with a 1.4 Å probe radius and replacing organic cations in Pore B with H⁺.

With reference to Table 1, the size of the polyhedra on an edge ranges from 20.0 Å to 28.5 Å, and the free pore diameter of Pore A ranges from 3.8 Å to 9.4 Å, the fixed pore diameter of Pore A ranges from 7.0 Å to 13.4 Å. The volume of space within the polyhedra (Pore A) is modulated from 16% to 27.2% of the total crystal volume. However, the volume of space between the polyhedra (Pore B) is significantly larger than that found within the polyhedra as it ranges from 28.8% to 63.0% of the total crystal volume. Due to the interstitial location of all dimethylammonium counter-ions, Pore B volumes are further reduced by ˜4% when included in the calculations. While the counter-ions represent a small fraction of the space of Pore B, they have a significant impact on the volume that can be accessed by a guest molecule. In the most drastic case, Pore B accessible volume for MOP-54 is merely 13 Å³/u.c compared to 2750 Å³/u.c when counter-ions are not included. The total open space (Pore A+Pore B) in the crystals of the series represents the vast majority of the crystal volume, ranging from 56.0% to 79.0%.

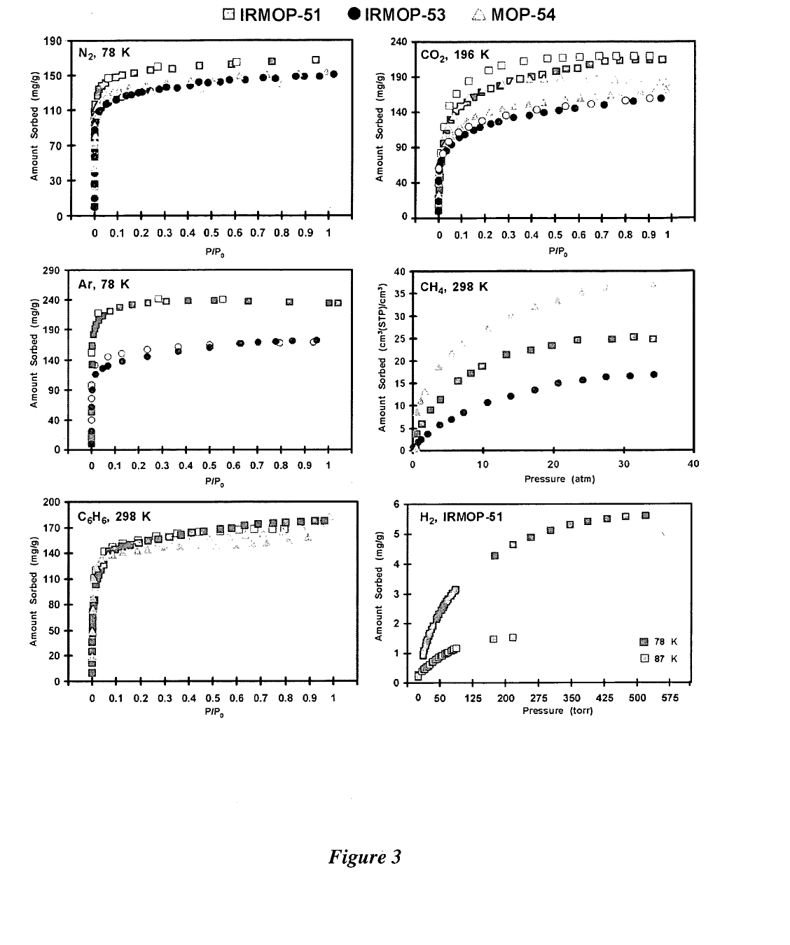

Establishing Permanent Porosity. To determine whether these structure have architectural rigidity and permanent porosity, we measured the gas adsorption isotherms of evacuated samples of IRMOP-51 (triclinic), 53, and MOP-54 (Table 2, FIG. 3). The N₂ sorption at 78 K for all three compounds revealed reversible Type I isotherms which are characteristic of microporous materials. Respective N₂ uptakes of 101, 57, and 109 cm³ (STP)/cm³ are observed that correspond to 23, 20, and 22 N₂ molecules per formula unit (Table 2). Using the BET model, the apparent surface areas (Aₛ) of IRMOP-51, 53, and MOP-54 were calculated to be 480, 387, and 424 m²/g, respectively. By extrapolation of the Dubinin-Radushkevich (DR) equation, the respective pore volumes (Vₚ) were estimated to be 0.18, 0.10, and 0.20 cm³/cm³.

TABLE 2
Sorption Data for Metal-Organic Polyhedra.

| | | uptake | guest/ | Aₛ | Vₚ |
|---|---|---|---|---|---|
| (IR)MOP-n | guest | (cm³ STP/cm³) | f.u.^{a} | (m²/g) | (cm³/cm³) |
| 51 | N₂ | 101 | 23 | 480 | 0.18 |
| | Ar | 106 | 24 | — | 0.16 |
| | CO₂ | 74 | 17 | — | 0.16^{b} |
| | C₆H₆ | 0.14 | 8 | — | 0.17 |
| | CH₄ | 25 | 5.6 | — | — |
| | H₂^{c} | 60 | 12.5 | — | — |
| 53 | N₂ | 57 | 20 | 387 | 0.10 |
| | Ar | 42 | 15 | — | 0.07 |
| | CO₂ | 32 | 12 | — | 0.06^{b} |
| | CH₄ | 17 | 5.9 | — | — |
| 54 | N₂ | 109 | 22 | 424 | 0.20 |
| | CO₂ | 63 | 13 | — | 0.14^{b} |
| | C₆H₆ | 0.18 | 9 | — | 0.20 |
| | CH₄ | 37 | 7.3 | — | — |

^{a}(IR)MOP f.u. = one truncated polyhedron (including counter-ions and ligated py) = [(CH₃)₂NH₂]₈[Fe₁₂O₄(link)ₓ(py)₁₂(SO₄)₁₂] (x = 6 for IRMOP-51 and IRMOP-53; x = 4 for MOP-54).
^{b}Density of liquid CO₂ at triple point = 1.18 g/cm³.
^{c}H₂ values reported at 500 torr and 78 K.

These compounds also show Type I isotherms upon exposure to Ar, CO₂, and C₆H₆ vapor (FIG. 3). Gradual hysteresis and incomplete desorption are evident in the CO₂ isotherms, a behavior previously observed in MOFs. Since CO₂ has a small kinetic diameter (3.3 Å), we speculate that such behavior is a result of the increased sorbate-sorbent interactions as the molecules access more acute pores. As the interstitial counter-ions may hinder gas diffusion and potentially occlude Pore B sorption sites, future studies will focus on exploring the influence of counter-ion identity on gas sorption properties.

In the area of microporous materials a wealth of conceptual approaches have been developed for preparing extended structures with high porosity and reversible Type I behavior. For zeolites, apparent surface areas up to 500 m²/g for Faujasite and pore volumes up to 0.47 cm³/cm³ for zeolite A have been reported. Metal-organic frameworks have been designed with apparent surface areas and pore volumes up to 4,500 m²/g and 0.69 cm³/cm³ for MOF-177. While gas uptake in metal-organic polygonal and polyhedral assemblies have been investigated, to our knowledge reversible Type I behavior has not been demonstrated. We speculate that such lack of permanent porosity is attributed to the flexible nature of single metal ion vertices. In this study, the SBU approach have been successfully applied to generate a series of discrete, microporous polyhedra with unprecedented reversible Type I behavior as well as apparent surface areas comparable to MOFs and some of the most porous zeolites.

To examine the potential utility of this series in the storage of gas fuels, IRMOP-51, 53 and MOP-54 were subjected to high-pressure CH₄ sorption at room temperature. All materials were nearly saturated at 35 atm, with respective uptakes of 25, 17, and 37 cm³ (STP)/cm³. These uptake values corresponds to approximately 5.6 (IRMOP-51), 5.9 (IRMOP-53), and 7.3 (MOP-54) methane molecules per formula unit. Furthermore, the hydrogen uptake for IRMOP-51 was measured at 78 and 87 K: the maximum uptake at each of the two given temperatures is 54.9 and 13.5 cm³ (STP)/cm³, equivalent to 12.5 and 3.1 H₂ molecules per formula unit. For comparison, MOF-5 takes up 67.4 cm³ (STP)/cm³ at 78 K and 500 torr. Thus, on a per volume basis, IRMOP-51 is comparable with MOF-5, having 81% of its hydrogen capacity in this temperature-pressure regime.

The isosteric heat of adsorption (qₛₜ) reflects the enthalpy change during the initial surface coverage and is a measure of the strength of the sorbate-sorbent interaction. Employing the Clausius-Clapeyron equation in conjunction with the 78 and 87 K hydrogen isotherms for IRMOP-51, qₛₜ was calculated to be 10.9±1.9 kJ/mol. This value is higher than those for activated carbons (6.4 kJ/mol) and planar graphite (4 kJ/mol) yet lower than some reported values for SWNT (19.6 kJ/mol), albeit debated. For more favorable uptake, the sorbate-sorbent interaction (qₛₜ) could potentially be increased to enable a material to reach its uptake capacity more efficiently, while allowing desorption to occur under moderate conditions. The comparable hydrogen uptakes of IRMOP-51 and MOF-5 could be attributed to the relative high isosteric heat of IRMOP-51.

The following examples illustrate the various embodiments of the present invention. Those skilled in the art will recognize many variations that are within the spirit of the present invention and scope of the claims.

### EXPERIMENTAL SECTION

### Synthesis of Compounds

The synthetic methods used to obtain pure crystalline samples of the compounds and their characterization procedures are described below. All reactions and purification steps were performed under aerobic conditions. Compounds are named as IRMOP-n or MOP-n, where ‘IRMOP’ refer to isoreticular (having the same topology) metal-organic polyhedron and ‘n’ is an integer assigned in roughly chronological order of discovery. We use the IRMOP designation for the truncated tetrahedral series, and MOP-n for the truncated heterocubane.

### Methods, Materials, and Characterization of Compounds

Iron (III) sulfate hydrate, 1,4-benzenedicarboxylic acid (H₂BDC), 4,4′-biphenyldicarboxylic acid (H₂BPDC), and triethylamine (TEA) were purchased from Aldrich Chemical Company and used as received without further purification. N,N-Dimethylformamide (DMF) (99.9%) and pyridine (py) (99.9%) were purchased from Fisher Chemicals. The organic acids, tetrahydropyrene-2,7-dicarboxylic acid (H₂HPDC), 4,4″-terphenyldicarboxylic acid (H₂TPDC), and 1,3,5-tris(4-carboxyphenyl)benzene (H₃BTB), were prepared according to published procedures. Elemental microanalyses of all products were performed at the University of Michigan, Department of Chemistry. Fourier transform infrared (FT-IR) spectra (4000-400 cm⁻¹) were obtained from KBr pellets using a Nicolet FT-IR Impact 400 system. Absorption peaks are described as follows: very strong (vs), strong (s), medium (m), and weak (w). Powder X-ray diffraction (PXRD) data were recorded on a Bruker AXS D8 Advance diffractometer operated at 40 kV, 40 mA for Cu K [symbol] , ([ [symbol] =1.5406 Å) with a scan speed of 3° min and a step size of 0.050° in 2 [symbol] . Simulated PXRD patterns were calculated using Powder Cell 2.2 from corresponding single crystal structures.

### [NH₂(CH₃)₂]₈[Fe₁₂O₄(BDC)₆(SO₄)₁₂(py)₁₂].G, IRMOP-50

Fe₂(SO₄)₃.xH₂O (0.20 g, 0.50 mmol) and 1,4-benzenedicarboxylic acid (H₂BDC) (0.083 g, 0.50 mmol) were placed in a 50 mL round bottom flask. 50 mL of N,N-dimethylformamide (DMF) and 130 μL neat triethylamine (TEA) were added to the reaction flask. The heterogeneous reaction mixture was capped and allowed to stir for 24 h. A 6 mL aliquot of this heterogeneous reaction solution was placed in a glass scintillation vial (20 mL capacity), to which 4 mL of pyridine was added and capped, heated to 100° C. for 48 h and removed to cool to room temperature. After 20 d, a few orange octahedral crystals of IRMOP-50 formed on the vial wall (2% yield based H₂BDC). Unlike other IRMOPs reported below, IRMOP-50 was difficult to obtain in reasonable yield. Only enough material was isolated to complete single crystal X-ray diffraction and FT-IR analysis. FT-IR (KBr 4000−500 cm-1): 3436 (m), 3068 (m), 2939 (m), 2815 (w), 1658 (s), 1582 (vs), 1505 (m), 1436 (s), 1407 (vs), 1222 (s), 1147 (vs), 1035 (s), 993 (s), 830 (w), 750 (m), 685 (m), 663 (m), 597 (m), 555 (s), 479 (w).

### [NH₂(CH₃)₂]₈[Fe₁₂O₄(SO₄)₁₂(BPDC)₆(py)₁₂].G, IRMOP-51 triclinic and Cubic Forms

Fe₂(SO₄)₃.xH₂O (0.20 g, 0.50 mmol) and 4,4′-biphenyldicarboxylic acid (H₂BPDC) (0.12 g, 0.50 mmol) were placed in a 50 mL round bottomed flask. 50 mL of N,N-dimethylformamide (DMF) and 130 μL neat triethylamine (TEA) were added to the reaction flask. The heterogeneous reaction mixture was capped and allowed to stir for 24 h at room temperature. For the cubic phase, a 2.4 mL aliquot of the mixture was placed in a glass scintillation vial (20 mL capacity), to which 3.6 mL of pyridine was added. The vial was capped and heated to 100° C. for 48 h, then cooled to room temperature to give orange crystalline solid of cubic IRMOP-51 (28% yield based on H₂BPDC link). For the triclinic phase, a 1.5 mL aliquot of the heterogeneous mixture was placed in a Pyrex tube (i.d.×o.d.=8×10 mm2, 140 mm length) to which 1.5 mL of pyridine was added. The tube was subsequently flash frozen, evacuated, flame sealed and heated to 115° C. (5° C./min) for 40 h and cooled (0.5° C./min) to room temperature. The resulting orange crystalline product was collected, washed with 2×5 mL of DMF and 2×5 mL of cyclohexane to give triclinic IRMOP-51 (38% yield based on H₂BPDC). All analytical methods subsequently described were performed using the triclinic phase of IRMOP-51. Anal. Calcd. for C₂₁₅H₃₄₇N₃₇O₁₂₁Fe₁₂S₁₂=[NH₂(CH₃)₂]₈[Fe₁₂O₄(BPDC)₆(SO₄)₁₂(py)₁₂].(DMF)₁₅(py)₂(H₂O)₃₀: C, 40.09; H, 5.43; N, 8.05. Found: C, 39.86; H, 5.48; N, 8.22. FT-IR (KBr, 3500−400 cm-1): 3439 (s), 3068 (m), 2979 (m), 2941 (m), 2805 (m), 2737 (m), 2678 (m), 2491 (w), 1712 (w), 1655 (s), 1604 (s), 1592 (s), 1543 (m), 1494 (m), 1447 (m), 1418 (vs), 1226 (s), 1181 (m), 1143 (s), 1126 (vs), 1050(s), 1037(s), 983 (s), 860(w), 845 (w), 795 (w), 774 (m), 702 (m), 681 (m), 661 (m), 601 (s), 476 (m).

### [NH₂(CH₃)₂]₈[Fe₁₂O₄(SO₄)₁₂(HPDC)₆(py)₁₂].G, IRMOP-52

Equimolar amounts of Fe₂(SO₄)₃.x(H₂O) (0.05 g, 0.13 mmol) and tetrahydropyrene-2,7-dicarboxylic acid (H₂HPDC) (0.04 g, 0.13 mmol) were suspended at room temperature in a 50 mL round bottom flask containing 20 mL of a 1:1 ratio of N,N-dimethylformamide and pyridine. 50 μL of neat triethylamine was added to this solution. The reaction flask was capped and stirred at room temperature for 72 h. A 1.2 mL aliquot of the stirring heterogeneous reaction solution was placed in a Pyrex tube (i.d.×o.d.=8×10 mm2, 140 mm length) followed by the addition of 1.8 mL of pyridine. The tube was subsequently flash frozen, evacuated, flame sealed and heated to 115° C. (5° C./min) for 32 h. Upon cooling to room temperature (0.5° C./min) and allowing the reaction to stand for several weeks, orange crystalline solid of IRMOP-52 formed along the tube walls from the orange homogeneous solution. Crystalline IRMOP-52 product was separated from the amorphous material and yellow crystalline impurity by density separation (bromoform/CH₂Cl₂). The isolated product (5% based on H₂HPDC) was washed with 3×5 mL of DMF and 1×5 mL of cyclohexane. Anal. Calcd. for C₂₁₁H₃₁₉O₁₁₅N₂₉S₁₂Fe₁₂=[NH₂(CH₃)₂]₈[Fe₁₂O₄(HPDC)₆(SO₄)₁₂(py)₁₂].(DMF)₉(H₂O)₃₀: C, 41.16; H, 5.22; N, 6.60. Found: C, 41.15; H, 5.32; N, 6.86. FT-IR (KBr, 3500−400 cm-1): 3433 (s), 3070 (m), 2937 (m), 2894 (m), 2834 (m), 1643 (m), 1605 (s), 1584 (s), 1544 (s), 1486 (m), 1466 (s), 1433 (s), 1404 (vs), 1352 (m), 1225 (s), 1127 (vs), 1066 (s), 1039 (vs), 984 (s), 791 (w), 752 (m), 701 (m), 604 (s), 476 (m).

### [NH₂(CH₃)₂]₈[Fe₁₂O₄(SO₄)₁₂(TPDC)₆(py)₁₂].G, IRMOP-53

Fe₂(SO₄)₃.xH₂O (0.19 g, 0.47 mmol) and 4,4′-terphenyldicarboxylic acid (H₂TPDC) (0.15 g, 0.47 mmol) were placed in a 50 mL round bottom flask, to which 15 mL of N,N-dimethylformamide (DMF), 15 mL of pyridine, and 130 μL neat triethylamine (TEA) were added. The heterogeneous reaction mixture was capped and allowed to stir at room temperature for 24 h. A 6 mL aliquot of the stirring heterogeneous reaction solution and 4 mL of pyridine were added to a glass scintillation vial (20 mL capacity). The vial was capped and heated to 105° C. (5° C./min) for 24 h and cooled (0.5° C./min) to room temperature to give an orange/red homogeneous solution. After 4 days at room temperature, the orange product crystallized as plates of IRMOP-53 on the vial walls (31% yield based on H₂TPDC). Crystals of IRMOP-53 were isolated, washed with 3×10 mL of pyridine, and 1×10 mL of cyclohexane. Anal. Calcd. for C₂₅₂H₂₇₄N₂₈O₇₇Fe₁₂S₁₂=[NH₂(CH₃)₂]₈[Fe₁₂O₄(SO₄)₁₂(TPDC)₆(py)₁₂].(py)₇ (DMF) (C₆H12)3: C, 50.60; H, 4.62; N, 6.56. Found: C, 50.59; H, 4.39; N, 6.48. FT-IR (KBr, 3500-400 cm⁻¹): 3427 (s), 3074 (m), 2983 (m), 2807 (m), 2499 (w), 1607 (vs), 1593 (vs), 1555 (s), 1422 (vs), 1226 (s), 1146 (vs), 1120 (vs), 1038 (s), 1009 (s), 985 (s), 844 (w), 786 (s), 708 (m), 603 (m), 547 (m).

### NH₂(CH₃)₂]₈[Fe₁₂O₄(SO₄)₁₂(BTB)₄(py)₁₂].G, MOP-54

A 3:2 molar ratio of Fe₂(SO₄)₃.x(H₂O) (0.06 g, 0.15 mmol) and 1,3,5-tris(4-carboxyphenyl)benzene (H₃BTB) (0.044 g, 0.10 mmol) were suspended in a 20 mL solution of a 1:1 ratio of N,N-dimethylformamide (DMF) and pyridine using a 50 mL round bottom flask. 150 μL of neat triethylamine were added to this mixture and the reaction capped and stirred at room temperature for 72 h. A 3 mL aliquot of the stirring heterogeneous reaction solution was placed in a Pyrex tube (i.d.×o.d.=8×10 mm2, 140 mm length). The tube was flash frozen, evacuated, flame sealed and heated to 115° C. (5° C./min) for 42 h and cooled (0.5° C./min) back to room temperature. The octahedral orange crystals of MOP-54 which formed during the isotherm were separated from the amorphous material and yellow crystalline impurity by density separation (bromoform/pyridine). The isolated product (20.2% yield based on H₃BTB) was washed with 3×5 mL pyridine and 1×5 mL cyclohexane. Anal. Calcd. for C₂₃₀H₃₀₈N₃₄O₁₀₃Fe₁₂=[NH₂(CH₃)₂]₈[Fe₁₂O₄(BTB)₄(SO₄)₁₂(py)₁₂].(DMF)₁₂(py)₂(H₂O)₁₅: C, 44.19; H, 4.97; N, 7.63. Found: C, 44.15; H, 5.06; N, 7.63. FT-IR (KBr, 3500−400 cm-1): 3425 (vs), 2841 (s), 2809 (m), 2683 (m) 2490 (w), 1715 (m), 1661 (vs), 1611 (s), 1550 (m), 1535 (m), 1413 (vs), 1214 (s), 1125 (vs), 1067 (s), 1036 (s), 991 (s), 857 (m), 810 (m), 785 (s), 701 (m), 665 (m), 607 (s), 505 (s), 417 (m).

### Single Crystal X-ray Diffraction Studies

The crystallographic measurements were made on a Bruker SMART APEX CCD area detector with graphite-monochromated Mo Kα radiation (λ=0.71073 Å) operated at 2000 W power (50 kV, 40 mA). Data collection was performed on specimens sealed in glass capillaries at 258(2) K unless otherwise noted. All structures were solved by direct methods and subsequent difference Fourier syntheses using the SHELX-TL software suite. Non-hydrogen atoms of the anionic IRMOP fragments and coordinated pyridines were refined anisotropically with hydrogens generated from riding models.

Solution and refinement of counter-ions and guest molecules varies between the structures: Both IRMOP-50 and the cubic form of IRMOP-51 have substantial residual electron density located within the pore structure; however, the exact identity of these guests could not fit to a chemically reasonable model because the guest molecules do not have the same symmetry as the overall structure. The structural model of IRMOP-50 was refined with guest and counter-ion contributions removed from the diffraction data using the by-pass procedure in PLATON. Therefore, the formulas for IRMOP-50 and the cubic form of IRMOP-51 correspond to the anionic truncated tetrahedral fragments only.

For the remaining structures, all counter-ions and some guest molecules were identified and refined. All remaining solvent accessible voids were calculated using PLATON, where the volume of space found within 1.2 Å of the van der Waals surface of the structural model were considered and reference guest volumes of 40 Å³ and 100 Å³ are given for water and pyridine, respectively.

For the triclinic form of IRMOP-51, in addition to the tetrahedral fragments (2 per unit cell), all dimethylammonium counter-ions (16 per unit cell) and most guest molecules (23 DMF, 19 pyridine, and 16 water per unit cell) were resolved in the structure, these account for 87.3% of the unit cell volume (16,878.6 Å³). Due to large thermal motions, some guest molecules, particularly DMF, were refined under restrained conditions. The remaining void space (12.7%) in the structural model is localized in two pockets (0,0,0 and 1,0,0.50) with volumes, 873 Å³ and 505 Å³, that correspond to approximately 8 and 5 DMF or pyridine molecules, respectively.

For IRMOP-52, in addition to the tetrahedral fragments (4 per unit cell), all dimethylammonium counter-ions (32 per unit cell) and most guest molecules (24 DMF, 40 pyridine, and 32 water per unit cell) were resolved, they account for 85.6% of the unit cell volume (35,418.0 Å³). Due to their large thermal motions, most of these guests were refined isotropically under restrained conditions. The remaining void space (14.4%) in the structural model is localized in two pockets (0.137,0.333,0.164 and 0,0.831,0.250), and sites related by symmetry, with volumes, 380 Å³ and 472 Å³, and correspond to approximately 3 and 4 additional DMF or pyridine molecules, respectively.

For IRMOP-53, in addition to the tetrahedral fragments (2 per unit cell), all dimethylammonium counter-ions (16 per unit cell) and some guest molecules (14 pyridine per unit cell) were resolved in the structural model, unidentified electron density was modeled as oxygen of water (30 water molecules per unit cell) and together, the above species account for 55.6% of the unit cell volume (26,568.0 Å³). Due to low data resolution (0.8 Å), disorder, and diffuse scattering, the remaining void space (44.4%) was not successfully modeled.

For MOP-54, in addition to the heterocuboidal fragments (4 per unit cell), all dimethylammonium counter-ions (32 per unit cell) and the majority of guest molecules (16 DMF and 8 pyridine per unit cell) were resolved in the structural model, unidentified electron density was modeled as oxygen of water (100 water molecules per unit cell) and together, the above species account for 94.0% of the unit cell volume (29,512.0 Å³). The remaining void space (6.0%) in the structural model is localized one pocket (0.500, 0.750, 0.125), and sites related by symmetry, with a volume of 282 Å³ that correspond to approximately 2 additional DMF or pyridine molecules.

### Magnetic Measurements

Solid-state magnetic measurements were performed using a Quantum Design MPMS-2S SQUID magnetometer. Approximately 10 mg of evacuated sample was packed under inert atmosphere into the sample holder and loaded into the magnetometer. A plot of magnetization versus field for data at 5, 10, 50, 150, and 250 K was found to be linear up to 15 kG. Therefore, variable-temperature magnetic susceptibility measurements were performed in the temperature range of 5-300 K at a constant magnetic field of 5 kG. A total of 64 data points were collected for each sample. In addition to correcting for the diamagnetic contribution from the sample holder, core diamagnetic corrections were calculated for each compound based on Pascal's constants to obtain the molar paramagnetic susceptibilities.

### Gas Sorption Isotherms (0 to 1 Bar)

A sample of a MOP in chloroform was transferred by a pipette to a quartz bucket and suspended in a previously described sorption apparatus. The excess solvent was removed from crystals at ambient temperature and 10⁻³ torr until no further weight loss occurred. Liquid nitrogen was used for N₂ and Ar isotherms (−195° C.), an acetone/dry ice slush was used for the CO₂ isotherm (−78° C.). The N₂ and Ar gases used were UHP grade; the CO₂ was of 99.8% purity. Benzene was purchased as anhydrous GC grade (99.8%) from Aldrich Chemical Co.

The adsorbate was dosed to the sample while monitoring mass, pressure and temperature. An isothermal data-point (Peq,Weq) was logged when the mass changed by less than 0.01 mg/300 sec. All gas isotherm data points were corrected for buoyancy and plotted versus relative pressure (p/po). Buoyancy corrections were determined from the slope (mbuoy) of the isotherm obtained by a standard aluminum foil weight, and applied to equilibrium pressure-weight data points as Wbuoy=Weq−mbouy Peq. The BET surface area (Aₛ) was calculated from N₂ isotherm points within the range of 0.005-0.032 P/Pₒ, assuming an N₂ cross-sectional area of 16.2 Å²/molecule. The pore volume was determined by extrapolating the Dubinin-Radushkevic equation with the assumption that the density of the adsorbate in the pore was the same as that of the pure adsorbate at isotherm. For all calculations reported on a per volume basis, it was assumed that all free, neutral guests were removed and the unit cell volumes maintained during evacuation.

For the hydrogen adsorption isotherm, the gas manifold was modified with a U-tube filled with molecular sieves. The sieves were flame-heated under vacuum, then immersed in a liquid nitrogen bath. UHP grade H₂ was passed through these sieves before entering the sample chamber.

### Gas Sorption Isotherms (0 to 35 Bar)

A 50-70 mg evacuated sample was charged with˜40 torr benzene while still in the low-pressure sorption apparatus mentioned above. Then the sample chamber was brought to ambient pressure with nitrogen. The benzene-filled sample was quickly transferred to a hemispherical quartz bucket (10 mm diameter, approximately 30 mg). The loaded bucket was suspended from a fused quartz spring and enclosed in a Ruska Mass-Sorption System (model 4403-800) outfitted with a Druck DPI 260 pressure gauge and PDCR 4010 pressure transducer. The sample was evacuated overnight until the cathometer (0.02 mm sensitivity) showed no further change in bucket height, whereupon the initial height (weight) was recorded. Doses of UHP methane were sequentially introduced to the sample at room temperature while monitoring the system pressure, temperature and sample height. Equilibrium was assumed when cathometer readings at 5-minute intervals showed no detectable change. Heights were converted to weights based on the spring constant (k>>0.500 mg/mm, calibrated per sample with standard aluminum foil weights), all data points were corrected for buoyancy as above and plotted versus increasing pressure.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1. A porous metal-organic polyhedra comprising:
a plurality of metal clusters, each metal cluster comprising:
two or more metal ions; and
a sufficient number of capping ligands to inhibit polymerization of the metal organic polyhedra; and
a plurality of multidentate linking ligands that connect adjacent metal clusters into a geometrical shape describable as a polyhedron with metal clusters positioned at one or more vertices of the polyhedron, wherein the metal-organic polyhedron remains porous in the absence of a templating agent.

2. The porous metal-organic polyhedra of claim 1 wherein each metal cluster comprises three or more metal ions.

3. The porous metal-organic polyhedra of claim 1 wherein the capping ligands are selected from the group consisting of Lewis bases.

4. The porous metal-organic polyhedra of claim 1 wherein the capping ligands are selected from the group consisting of anionic ions.

5. The porous metal-organic polyhedra of claim 1 wherein the capping ligands are selected from the group consisting of sulfate, nitrate, halogen, phosphate, amine, and mixtures thereof.

6. The porous metal-organic polyhedra of claim 1 wherein the metal-organic polyhedra have a pore volume per gram of metal-organic polyhedra greater than about 0.1 cm³/cm³.

7. The porous metal-organic polyhedra of claim 1 wherein the metal ion selected from the group consisting of Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, C²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁵⁺, Bi³⁺, and Bi⁺.

8. The porous metal-organic polyhedra of claim 1 wherein the plurality of metal clusters have the formula Fe₃O(CO₂)₃(SO₄)₃.

9. The porous metal-organic polyhedra of claim 1 wherein the multidentate linking ligand is described by formula I:
XₙY I
wherein X is CO₂⁻, CS₂⁻, NO₂, SO₃⁻, and combinations thereof;
n is an integer that is equal or greater than 2; and
Y is a hydrocarbon group or a hydrocarbon group having one or more atoms replaced by a heteroatom.

10. The porous metal-organic polyhedra of claim 9 wherein X is CO₂⁻.

11. The porous metal-organic polyhedra of claim 9 wherein Y comprises a moiety selected from the group consisting of a monocyclic aromatic ring, a polycyclic aromatic ring, alkyl groups having from 1 to 10 carbons, and combinations thereof.

12. The porous metal-organic polyhedra of claim 9 wherein Y is alkyl, alkyl amine, aryl amine, aralkyl amine, alkyl aryl amine, or phenyl.

13. The porous metal-organic polyhedra of claim 9 wherein Y is a C₁₋₁₀ alkyl, a C₁₋₁₀ alkyl amine, a C₇₋₁₅ aryl amine, a C₇₋₁₅ aralkyl amine, or a C₇₋₁₅ alkyl aryl amine.

14. The porous metal-organic polyhedra of claim 1 wherein the multidentate linking ligand is described by formula II: 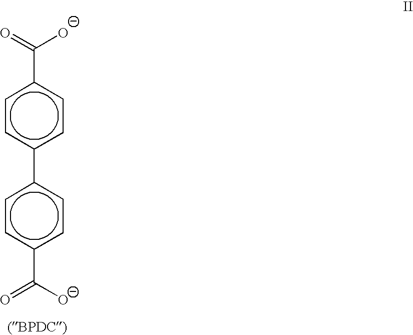
the porous metal-organic polyhedra has the formula [NH₂(CH₃)₂]₈[Fe₁₂O₄(BPDC)₆(SO₄)₁₂ (py)₁₂].

15. The porous metal-organic polyhedra of claim 1 wherein the multidentate linking ligand is described by formula III: 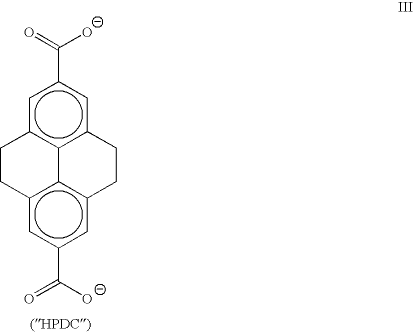
and the porous metal-organic polyhedra has the formula [NH₂(CH₃)₂]₈[Fe₁₂O₄(HPDC)₆(SO₄)₁₂(py)₁₂].

16. The porous metal-organic polyhedra of claim 1 wherein the multidentate linking ligand is described by has the formula IV: 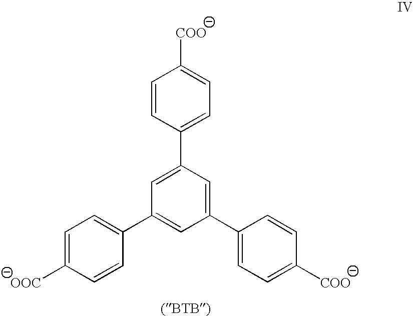
and the porous metal-organic polyhedra has the formula [NH₂(CH₃)₂]₈[Fe₁₂O₄(BTB₆)₄(SO₄)₁₂(py)₁₂]; or
the multidentate linking ligand is described by formula V: 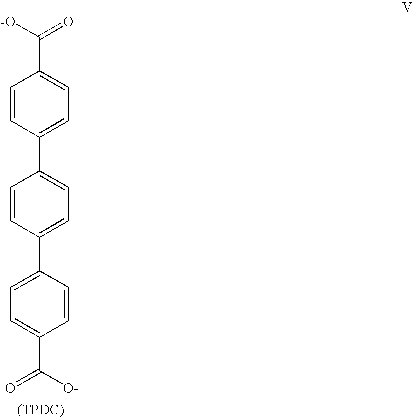
and the porous metal-organic polyhedra has the formula [NH₂(CH₃)₂]₈[Fe₁₂O₄(TPDC₆)₆(SO₄)₁₂(py)₁₂] (IRMOP-53); or
the multidentate linking ligand is described by formula VI; 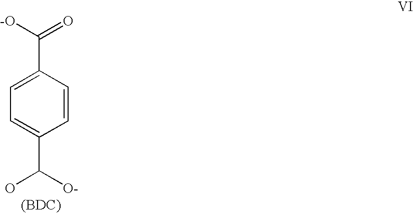
and the porous metal-organic polyhedra has the formula [NH₂(CH₃)₂]₈[Fe₁₂O₄(BDC₆)₆(SO₄)₁₂(py)₁₂] (IRMOP-50)).

17. The porous metal-organic polyhedra of claim 1 further comprising an adsorbed chemical species.

18. The porous metal-organic polyhedra of claim 17 wherein the adsorbed chemical species is selected from the group consisting of ammonia, carbon dioxide, carbon monoxide, hydrogen, amines, methane, oxygen, argon, nitrogen, argon, organic dyes, polycyclic organic molecules, and combinations thereof.

19. The porous metal-organic polyhedra of claim 1 further comprising a guest species.

20. The porous metal-organic polyhedra of claim 19 wherein the guest species is selected from the group consisting of organic molecules with a molecular weight less than 100 g/mol, organic molecules with a molecular weight less than 300 g/mol, organic molecules with a molecular weight less than 600 g/mol, organic molecules with a molecular weight greater than 600 g/mol, organic molecules containing at least one aromatic ring, polycyclic aromatic hydrocarbons, and metal complexes having formula MₘXₙ where M is metal ion, X is selected from the group consisting of a Group 14 through Group 17 anion, m is an integer from 1 to 10, and n is a number selected to charge balance the metal cluster so that the metal cluster has a predetermined electric charge, and combinations thereof.

21. A method of forming a porous metal-organic polyhedra, the method comprising:
combining a solution comprising a solvent, one or more metal ions; and counterions that complex to the porous metal-organic polyhedra as capping ligands to inhibit polymerization of the metal organic polyhedra;
with a multidentate linking ligand having more than 16 atoms which are incorporated in aromatic rings.

22. The method of claim 21 wherein the one or more metal ions are selected from the group consisting of Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, M²⁺, Re³⁺, Re²⁺, Fe³⁺, Fe²⁺, Ru³⁺, Ru²⁺, Os³⁺, Os²⁺, Co³⁺, C²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³+, As+, Sb⁵+, Sb³⁺, Sb⁺, Bi⁵⁺, Bi³⁺, Bi⁺, and combinations thereof.

23. The method of claim 21 wherein the counterions are selected from the group consisting of Lewis bases.

24. The method of claim 21 wherein the counterions are selected from the group consisting of sulfate, nitrate, halogen, phosphate, amine, and mixtures thereof.

25. The method of claim 21 wherein the multidentate linking is described by formula I:
XₙY I
wherein:
X is CO₂⁻, CS₂⁻, NO₂, SO₃⁻, and combinations thereof;
n is an integer that are equal or greater than 2; and
Y is a hydrocarbon group or a hydrocarbon group having one or more atoms replaced by a heteroatom.

26. The method of claim 21 wherein the solvent comprises a component selected from ammonia, hexane, benzene, toluene, xylene, chlorobenzene, nitrobenzene, naphthalene, thiophene, pyridine, acetone, 1,2-dichloroethane, methylenechloride, tetrahydrofuran, ethanolamine, triethylamine, N,N-dimethyl formamide, N,N-diethyl formamide, methanol, ethanol, propanol, alcohols, dimethylsulfoxide, chloroform, bromoform, dibromomethane, iodoform, diiodomethane, halogenated organic solvents, N,N-dimethylacetamide, N,N-diethylacetamide, 1-methyl-2-pyrrolidinone, amide solvents, methylpyridine, dimethylpyridine, diethylethe, and mixtures thereof.

27. The method of claim 21 wherein the solution further comprises a templating agent.

28. The method of claim 27 wherein the templating agent is selected from the group consisting of:
a. alkyl amines and their corresponding alkyl ammonium salts, containing linear, branched, or cyclic aliphatic groups, having from 1 to 20 carbon atoms;
b. aryl amines and their corresponding aryl ammonium salts having from 1 to 5 phenyl rings;
c. alkyl phosphonium salts, containing linear, branched, or cyclic aliphatic groups, having from 1 to 20 carbon atoms;
d. aryl phosphonium salts, having from 1 to 5 phenyl rings,
e. alkyl organic acids and their corresponding salts, containing linear, branched, or cyclic aliphatic groups, having from 1 to 20 carbon atoms;
f. aryl organic acids and their corresponding salts, having from 1 to 5 phenyl rings;
g. aliphatic alcohols, containing linear, branched, or cyclic aliphatic groups, having from 1 to 20 carbon atoms;
h. aryl alcohols having from 1 to 5 phenyl rings;
i. inorganic anions from the group consisting of sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, O²⁻, diphosphate, sulfide, hydrogen sulphate, selenide, selenate, hydrogen selenate, telluride, tellurate, hydrogen tellurate, nitride, phosphide, arsenide, arsenate, hydrogen arsenate, dihydrogen arsenate, antimonide, antimonate, hydrogen antimonate, dihydrogen antimonate, fluoride, boride, borate, hydrogen borate, perchlorate, chlorite, hypochlorite, perbromate, bromite, hypobromite, periodate, iodite, hypoiodite, and the corresponding acids and salts of said inorganic anions;
j. ammonia, carbon dioxide, methane, oxygen, argon, nitrogen, ethylene, hexane, benzene, toluene, xylene, chlorobenzene, nitrobenzene, naphthalene, thiophene, pyridine, acetone, 1,2-dichloroethane, methylenechloride, tetrahydrofuran, ethanolamine, triethylamine, trifluoromethylsulfonic acid, N,N-dimethyl formamide, N,N-diethyl formamide, dimethylsulfoxide, chloroform, bromoform, dibromomethane, iodoform, diiodomethane, halogenated organic solvents, N,N-dimethylacetamide, N,N-diethylacetamide, 1-methyl-2-pyrrolidinone, amide solvents, methylpyridine, dimethylpyridine, diethylethe, and mixtures thereof.

29. A method of designing porous metal-organic polyhedra, the method comprising:
selecting a first multidentate ligand as set forth in formula I:
(XₙY) I
wherein X is CO₂⁻, CS₂⁻, NO₂, SO₃⁻, and combinations thereof;
n is an integer that is equal or greater than 2; and
Y is a hydrocarbon group or a hydrocarbon group having one or more atoms replaced by a heteroatom;
forming a first metal-organic polyhedra with the first multidentate ligand;
measuring pore size or adsorption of a chemical species for the first metal-organic polyhedra;
forming a second first metal-organic polyhedra from a second multidentate ligand, the second multidentate ligand having a larger number of atoms than the first multidentate ligand;
measuring pore size or adsorption of a chemical species for the second metal-organic polyhedra; and
iteratively forming alternative second multidentate ligands from alternative second ligands with increasing numbers of atoms until a predetermined pore size for adsorption of a chemical species is attained.
